(19) United States
(12) Patent Application Publication
(10) Pub. No.: US 2012/0294724 A1
(43) Pub. Date: Nov. 22, 2012

(54) AERODYNAMIC FAIRING FOR A WIND TURBINE AND A METHOD OF CONNECTING ADJACENT PARTS OF SUCH A FAIRING

(75) Inventors: Peter Anthony Broome, Cowes (GB); Paul Trevor Hayden, Cowes (GB)

(73) Assignee: BLADE DYNAMICS LTD., Cowes, (GB)

(21) Appl. No.: 13/480,361

(22) Filed: May 24, 2012

Related U.S. Application Data
(63) Continuation of application No. PCT/GB2010/002189, filed on Nov. 26, 2010.

(30) Foreign Application Priority Data
Nov. 26, 2009 (GB) 0920749.9

(51) Int. Cl. F03D 11/00; B23P 11/00

(52) U.S. Cl. 416/223 R; 29/428

(57) ABSTRACT

A method for connecting adjacent parts (1A, 1B) of a wind turbine fairing. Two parts are abutted together to define an adhesive channel (14) between the two parts and a pair of spacers (12, 13). Adhesive is injected into the channel. One of the parts is provided with a stop (16) on a surface which is internal to the fairing allowing the two parts to be located correctly with respect to one another.

### CROSS-REFERENCE TO RELATED APPLICATIONS

This application is a continuation of Patent Cooperation Treaty International Patent Application PCT/GB2010/002189, filed Nov. 26, 2010, and entitled “AN AERODYNAMIC FAIRING FOR A WIND TURBINE AND A METHOD OF CONNECTING ADJACENT PARTS OF SUCH A FAIRING,” which is incorporated by reference herein in its entirety, and which claims priority to Great Britain Patent Application 0920749.9, filed on Nov. 26, 2009.

### BACKGROUND

1. Field of the Invention

The present invention relates to an aerodynamic fairing for a wind turbine and to a method for connecting adjacent parts of such a fairing.

2. Description of the Related Art

In recent times, there has been a demand for wind turbines of increasing size. The applicant has developed a number of modular blades to meet these requirements, for example, as disclosed in WO 2009/034291 and WO 2009/130467.

These blades have skin panels providing the aerodynamic fairing which are made up of a number of separate parts connected end to end along a spar to form one side of the aerodynamic fairing and a second set of parts connected along the other side of the spar to provide the other side of the fairing. The parts of the aerodynamic fairing, together with the spar parts of the blade are designed to be short enough that they can be shipped in a standard shipping container thereby ensuring that the parts are of a size which can be readily transported and manufactured with more accuracy.

Typically, the parts of the fairing are bonded together to make the aerodynamic surface of the blade. Two full length aerodynamic fairings are made in each case by coating adhesive onto one of the parts and placing an adjacent part onto the adhesive to bond them together to form the full length fairing. The two fairing halves are then bonded together along the leading and trailing edges again by coating adhesive onto one or both of the parts and pressing the two parts together. Alternatively, for a blade which contains an integral spar the fairing halves may be bonded together along their leading and trailing edges at the same time as they are bonded to the spar.

Although the fairing parts are much smaller than those of the prior art, they are still relatively large components and the accuracy of the bonding is very difficult to achieve over this scale. Also, the bond regions have a large variation in bond gap thickness and amount of adhesive used leading to large mass variations and problems of alignment between adjacent components. If uncontrolled these variations ultimately end up with large variations in blade mass and also aerodynamic accuracy, leading to poorer than designed performance of the blades in service.

US 2008/0075603 discloses bonding two shell halves of a turbine blade together along the length of the blade. One or both of the halves has a channel into which the adhesive is injected. There is no disclosure of how the two halves are aligned and this may be difficult to do in practice.

WO 2010/021340 which was not published until 4 Mar. 2010 discloses the adhesion of two components in a wind turbine fairing using flexible adhesive limiting members which define an adhesive channel. There is no disclosure of how the parts are aligned.

### SUMMARY

According to a first aspect of the present invention, there is provided a method for connecting adjacent parts of a wind turbine fairing, the method comprising abutting two parts together to define an adhesive channel between the two parts and a pair of spacers; and injecting adhesive into the channel wherein one of the parts is provided with a stop on a surface which is internal to the fairing allowing the two parts to be located correctly with respect to one another.

The spacers control the thickness of the channel into which the adhesive is injected so that the bond gap thickness can be set accurately.

The spacers may be separate components which are fixed to the fairings, but are preferably moulded integrally with the fairings as this is easier to manufacture.

Sufficient pressure may be applied to the parts that the spacers themselves are able to contain the adhesive as it is injected into the channel. However, preferably, at least one side of the channel is sealed in the vicinity of an adjacent spacer by a strip of sealing adhesive extending in parallel to the spacer. This is different from the application of adhesive in the prior art as the adhesive is applied in a much smaller quantity as it is required only to seal the joints and not to provide the full bonding strength between the two parts. Further, the adhesive applied to seal the channel has no effect on the adhesive gap which is entirely determined by the spacers.

The invention is applicable to the joints between adjacent fairing parts along the length of one side of the fairing, and is also applicable to the joint between the two halves of the fairing.

The stop may take the form of a flange extending along in the direction of the channel. The flange preferably forms a groove which is preferably tapered. The sealing adhesive may be placed into this groove before the distal edge of the adjacent panel is inserted into the groove. This provides a simple way of aligning and locating the two parts and sealing them at one edge. The opposite side of the channel may be sealed by the application of an adhesive between the two panels at the external surface of the fairing.

In the case of the joint between the upper and lower fairing parts, the joint is typically a butt joint. In this case, a bead of sealing adhesive is preferably applied along one of the fairings at a part furthest from the external surface fairing. The two joints are then located with respect to one another. There may be one or more complimentary protrusions or recesses on the two parts to ensure that the joints are correctly aligned. Once they are correctly aligned, adhesive may then be applied along the exposed edge of the joint to seal the opposite side of the channel before the adhesive is injected in the channel to bond the parts together.

Preferably, at least one of the adjacent parts is shaped in the vicinity of the adhesive channel such that selected parts of the channel are thicker than the surrounding parts, these selected parts forming one or more flow channels to help the adhesive to be distributed from the point of injection along the adhesive channel.

Optionally, a strip of laminate may be bonded to the fairing parts along the external surface of the joint. This prevents the possibility of the joint being peeled apart if it were ever subjected to significant axial loads. Preferably, the strip is positioned in a shallow recess so that it is flush with the surface of the remainder of the fairing parts.

The two parts may be held together during the bonding operation by an external means such as a jig. Alternatively or additionally the parts may be connected by mechanical fixings during the bonding operation which may either be left in place or removed once the bonding is complete.

According to a second aspect of the invention, there is provided an aerodynamic fairing for a wind turbine, the fairing have two parts which are bonded together at a joint region, wherein, at the joint region, the parts have a pair of spacers arranged so that an adhesive channel is defined between the two parts and the spacers, whereby the spacers determine the width of the channel wherein one of the parts is provided with a stop on a surface which is internal to the fairing allowing the two parts to be located correctly with respect to one another.

The preferred features set out above may equally be applied to this second aspect of the invention.

### BRIEF DESCRIPTION OF THE DRAWINGS

An example of an aerodynamic fairing and method of assembly in accordance with the present invention will now be described with reference to the accompanying drawings, in which:

FIGS. 1A-1E are perspective views showing the assembly process of a known turbine blade which is provided for background information;

FIGS. 2A-2E are cross-sectional views through a joint between a pair of adjacent fairing parts in various stages of assembly;

FIGS. 3A-3D are schematic plan views showing various configurations of flow channel; and

FIGS. 4A-4D are cross-sections through the leading or trailing edge of the blade showing the joint between the upper and lower rows of fairing panels in various stages of assembly.

### DETAILED DESCRIPTION

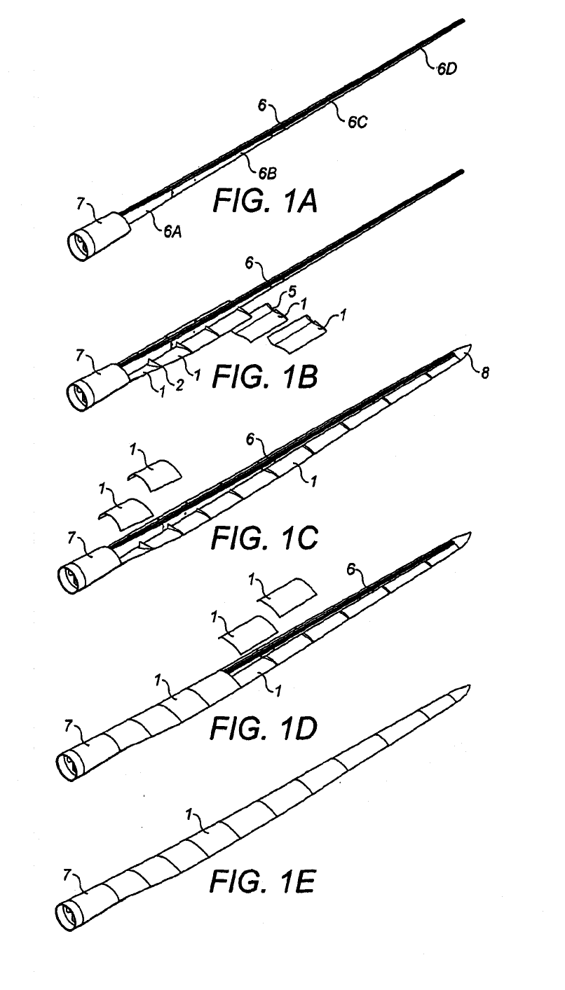

The basic overall design of modular blade to which the present invention is applied is shown in FIGS. 1A-1E. This figure is taken from WO 2009/130467.

FIG. 1A shows a sub-assembly of the spar 6 and root 7. The spar 6 may have a one-piece construction or may be assembled from a plurality of spar modules 6A, 6B, 6C and 6D.

Beginning at the root end, the skin panels 1 are attached to the spar. The panel closest to the root end has a profile at its route end which matches the profile of the distal end of the root 7. In the illustrated example the root has a tapered shape such that the distal end of the root 7 has a similar shape to the corresponding edge of the skin panels 1. However, if a more conventional circular root end is used, the panel adjacent to the root may be provided with a more complex shape to bridge the transition from the circular shape of the root to the aerodynamic cross-section of the remainder of the blade.

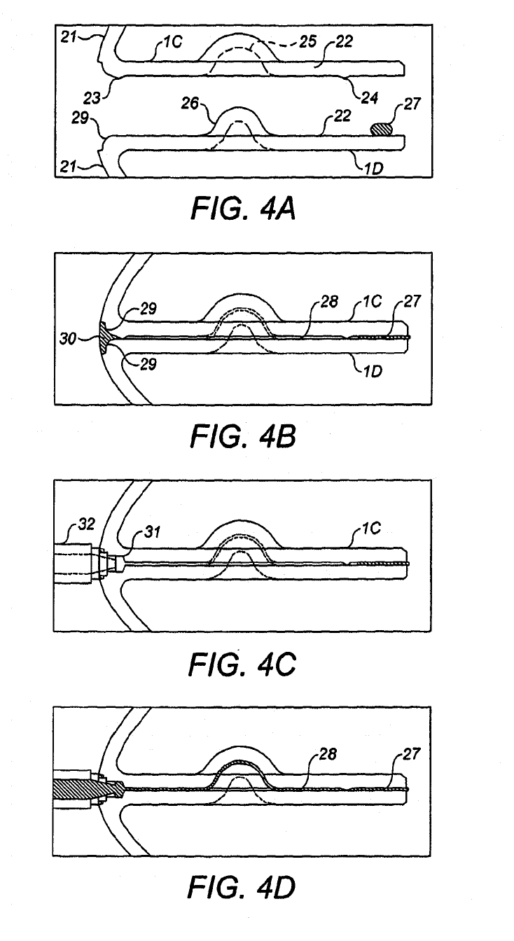

As shown in FIG. 1B, successive skin panels 1 are bonded to the spar 6. Four skin panels are shown bonded in place, while the next two panels to be attached are shown separately from the spar. The root end of each one is bonded to the recess 3 of an adjacent panel and the flange at the opposite end is bonded to the spar. As shown in FIG. 4C all of the panels for the lower surface are bonded in place. These decrease in cross-section towards the tip then terminate in a specially shaped tip section 8.

Once the lower surface is complete, the same process is repeated for the upper surface as shown in FIG. 1D.

Alternative construction methods are possible. Rather than assembling the complete spar, assembling the complete lower surface and assembling the complete upper surface, it would also be possible to begin to start applying skin panels to the upper surface before all of the skin panels are attached to the lower surface. Also, the process of applying the skin panels may begin before the complete spar has been assembled. It would even be possible to manufacture a plurality of modules, each having one of the spar segments 6A-6D surrounded by a plurality of skin panels. These modules could then be assembled to form the complete blade.

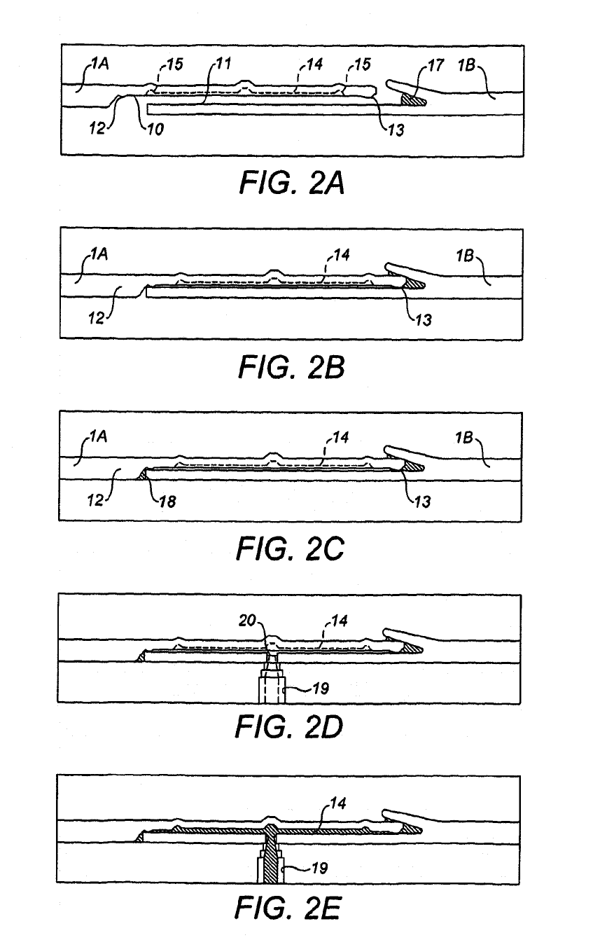

The joint between adjacent skin panels along the length of the blade will now be described with reference to FIGS. 2A-2E.

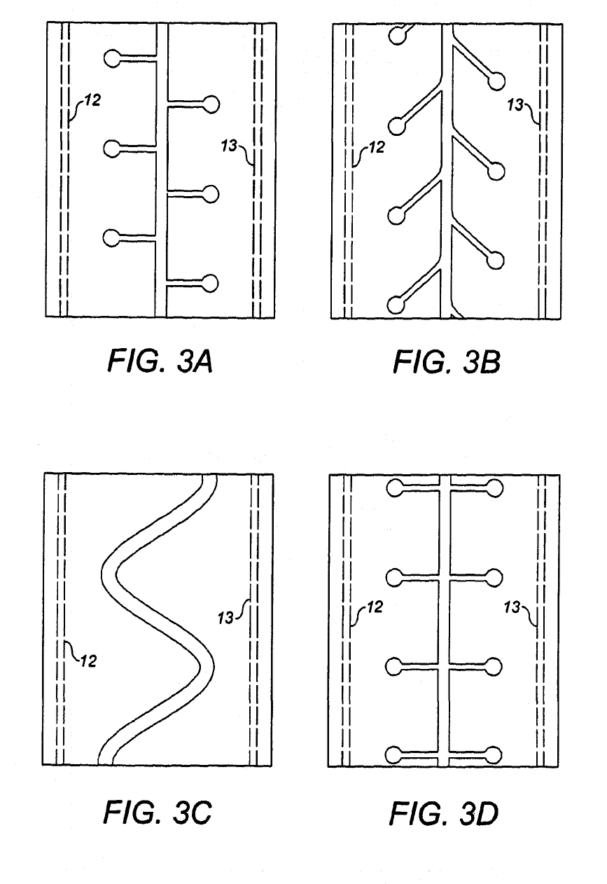

In all of FIGS. 2A-2E, the external face of the skin panels is the downward facing surface, while the upward facing surface is internal to the blade. The figures show the right-hand edge of a first skin panel 1A and the left-hand edge of a second skin panel 1B. The first skin panel 1A is provided on its outer surface with a recess 10 which overlaps and mates with a recess 11 on the inwardly facing surface of a second skin panel 1B. The recesses 10, 11 ensure that the overall thickness of the fairing in the vicinity of the joint is approximately the same as the thickness of the surrounding areas. Within the recess 10 on the first skin panel 1A, there are a pair of spacers 12, 13 which extend in a direction perpendicular to the plane of the paper which, in use, will be in the transverse direction of the blade. The recess 10 also defines an adhesive channel 14 for the adhesive which is described in more detail below. The adhesive channel 14 has a plurality of flow channels 15 provided by portions with increased thickness which facilitate the flow of adhesive along the joint in the manner described below. A number of possible configurations of flow channels 15 are shown in FIGS. 3A to 3D.

Although, as described above, the spacers 12, 13 and adhesive channel 14 are provided on the outwardly facing surface of the first skin panel, either or both of these may be provided additionally or alternatively on the inwardly facing surface of the recess 11 of the second skin panel 1B.

The second skin panel 1B has a flange 16 which projects inwardly at an acute angle to form a hook-like structure and runs perpendicular to the plane of the paper as shown in FIG. 2A which represents the direction transverse to the blade in use.

The manner in which the two skin panels are joined will now be described. Before assembly, the parts are unpacked and the bonding surfaces are degreased.

A bead of adhesive 17 is applied between the recess 11 and flange 16. As shown in FIG. 2B, the two skin panels 1A and 1B are then brought together into the correct alignment. The parts are held by mechanical fixings such as rivets. The dimensional accuracy and shape of the parts are checked by holding them in a jig for assembly. At this point, the distal end of first skin panel 1A is located within the groove formed between the recess 11 and flange 16 to ensure lateral alignment between the two skin panels. Also, the spacers 12, 13 abut against the face of the recess 11 thereby determining precisely the dimensions of the adhesive channel 14. The adhesive 17 seals the right-hand side of the channel 14.

The adhesive may be polyurethane, epoxy or acrylic based structural adhesive. In a preferred example it is an epoxy based adhesive with a viscosity of 1000-2000 mPas at 25 degrees C. and a cured shear strength of 20-50 MPa.

As the next step shown in FIG. 2C, a bead of adhesive 18 is applied to the outer surface of the assembled skin panels 1A and 1B which seals the channel at the left-hand side of the channel 14. An adhesive injector 19 is then positioned in adhesive orifice 20. In use, there may be a number of adhesive orifices spaced along the length of the joint. Adhesive is then injected into the adhesive channel 14 as shown in FIG. 2E. The adhesive runs along the adhesive channel 14 assisted by the flow channels 15 ensuring even distribution of the adhesive along the channel.

If required, the external seam 18 is cleaned and an anti-peel strip (not shown) is laminated onto the outside of the seam.

The joints between the upper and lower layers of skin panels will now be described with reference to FIG. 4A to 4B. These follow the same principle as described above with reference to FIGS. 2A-2E, but the detail is somewhat different.

The joint described here is applicable to either the leading or trailing edge of the blade. In practice, although the joint is shown precisely at the leading or trailing edge in FIGS. 4A to 4D, it may be slightly offset from this location. In this case, the pair of skin panels are designated as upper skin panel 1C and lower skin panel 1D each skin panel has an outwardly facing surface 21 and an internal flange 22. For the upper skin panel 1C, the internal flange 22 faces downwardly while for the lower skin panel 1D the internal flange 22 faces upwardly.

As shown in FIG. 4A, the internal flange 22 of the upper skin panel 1C has a pair of spacers 23, 24 facing downwardly from its lowermost surface. These extend into the plane of the paper in FIG. 4A which represents the direction along the length of the blade.

The flange 22 of the upper skin panel 1C is also provided with one or more locating recesses 25. The lower skin panel 1D has corresponding protrusions 26 which mate with the recesses 25 to ensure that the upper and lower panels are correctly aligned.

The spacers 23, 24 are shown on the upper skin panel 1C, but one or both of these may be additionally or alternatively on the lower skin panel 1D. Similarly, the arrangement of recesses 25 and protrusions 26 may be inverted, or there may be a mixture of recesses and protrusions on one of the panels which mate with the opposite configuration on the opposite panel.

The manner in which the upper 1C and lower 1D skin panels are assembled will now be described.

Firstly, a bead of adhesive 27 is applied running along the innermost part of the outwardly facing surface of the internal flange of lower skin panel 1D. The bead extends into the plane of the paper of FIG. 4A which is the longitudinal direction of the blade. The bead 27 could also be applied to the corresponding surface on the upper skin panel 1C, but it is obviously preferable to apply it to an upwardly facing surface.

The two parts are then engaged with one another as shown in FIG. 2B to form an adhesive channel 27 which corresponds to the adhesive channel 14 in the previous example. The channel may similarly be provided with portions of increased thickness to aid the ease of flow through the channel. The bringing together of the upper and lower skin panels 1C and 1D flattens out the bead of adhesive 27 as shown in FIG. 4B.

Recesses 29 are provided in the leading edges of each of the upper 1C and lower 1D skin panels. When the two skin panels are brought together, the resulting recess is filled with a bead of adhesive 30 extending into the plane of the paper in FIG. 4B, namely in the longitudinal direction of the blade. The adhesive beads 27 and 30 seal the sides of the channel 28.

FIG. 4C and 4D show the skin panels 1C and 1D in a different plane from those shown in FIGS. 4A and 4B. The section of FIG. 4C is taken through the part of the skin panels 1C and 1D which are provided with an adhesive injection orifice 31. An adhesive nozzle 32 is put into this orifice (there may be a plurality of such orifices then arranged along the length of the blade) and adhesive is injected into the channel 28 as shown in FIG. 4D.

Once the adhesive nozzle 32 has been removed, the space that it occupied can be filled in with additional adhesive to provide a smooth finish at the leading edge.

What is claimed is:

1. A method for connecting adjacent parts of a wind turbine fairing, the method comprising abutting two parts together to define an adhesive channel between the two parts and a pair of spacers; and injecting adhesive into the channel; wherein one of the parts is provided with a stop on a surface which is internal to the fairing allowing the two parts to be located correctly with respect to one another.

2. A method according to claim 1, wherein a least one side of the channel is sealed in the vicinity of an adjacent spacer by a strip of sealing adhesive extending in parallel to the spacer.

3. A method according to claim 1, wherein the stop is a flange which forms a groove.

4. A method according to claim 2, wherein the sealing adhesive is placed into the groove.

5. A method according to claim 1, wherein, at least one of the parts is shaped in the vicinity of the adhesive channel such that selected parts of the channel are thicker than the surrounding parts, these selected parts forming one or more flow channels to help the adhesive to be distributed from the point of injection along the adhesive channel.

6. A method according to claim 1, wherein a strip of laminate is bonded to the fairing parts along the external surface of the joint.

7. A method according to claim 1, wherein the joint is a lap joint.

8. A method according to claim 1, wherein the joint is a butt joint.

9. A method according to claim 1, wherein the two parts are held together during the bonding operation by a jig.

10. A method according to claim 1, wherein the two parts are held together during the bonding operation by mechanical fixings.

11. A method according to claim 1, wherein the adhesive has a viscosity of between 1000 and 2000 MPas at 25 degrees C.

12. A method according to claim 1, wherein at least one of the joints runs transversely to the fairing.

13. A method according to claim 1, wherein at least one of the joints runs longitudinally to the fairing.

14. A method according to claim 1, wherein the spacers are molded integrally with the parts.

15. A method according to claim 1, wherein the stop is molded integrally with the part.

16. A method according to claim 1, wherein the two parts are adjacent panels on a single side of the fairing.

17. An aerodynamic fairing for a wind turbine, the fairing have two parts which are bonded together at a joint region, wherein, at the joint region, the parts have a pair of spacers arranged so that an adhesive channel is defined between the two parts and the spacers, whereby the spacers determine the width of the channel wherein one of the parts is provided with a stop on a surface which is internal to the fairing allowing the two parts to be located correctly with respect to one another.

18. A fairing according to claim 17, wherein the two parts are adjacent panels in a single side of the fairing.

19. A fairing according to claim 17, wherein the fairing panels overlap one another at the joint region.

20. A fairing according to claim 18, wherein the fairing panels overlap one another at the joint region.

21. A method according to claim 2, wherein the stop is a flange which forms a groove.
